(19) United States
(12) Patent Application Publication
(10) Pub. No.: US 2008/0003559 A1
(43) Pub. Date: Jan. 3, 2008

(54) Multi-User Multi-Input Application for Education

(75) Inventors: Kentaro Toyama, Bangalore (IN); Udai Singh Pawar, Bangalore (IN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/465,221

(22) Filed: Aug. 17, 2006

(30) Foreign Application Priority Data
Jun. 20, 2006 (IN) 1455/DEL/2006

(51) Int. Cl. G09B 3/00

(52) U.S. Cl. 434/350

(57) ABSTRACT

A multi-user multi-input application for education is described. In one aspect, a user interface (UI) presenting pedagogical tasks of varied type and multiple cursors are presented on a single display. Each cursor is assigned to a particular user of multiple users. Actions associated with cursor control event data are mapped to particular users. Relative successes of respective ones of the users in completing particular types of pedagogical tasks of are determined.

### RELATED APPLICATIONS

This application claims priority to pending India Patent Application serial no. 1455/DEL/2006, which was filed with the Government of India Patent Office on Jun. 20, 2006, and which is hereby incorporated by reference.

### BACKGROUND

A distinct feature observed in computer use in schools or rural kiosks in developing countries is the high student-to-computer ratio. Commonly, five or more children can be seen crowding around a single computer monitor display. One reason for this is because schools in rural kiosks in developing countries are rarely funded to afford one general purpose computing device per child in a classroom. It is common for only one child to control the mouse (pointing device) and interact with an application, while other children surrounding the display remain passive onlookers because they have no operational control of the application. In such a scenario, learning benefits appear to accrue primarily to the child with control of the application, with the other students missing out on potential learning opportunities.

### SUMMARY

Systems and methods for a multi-user multi-input application for education are described. In one aspect, a user interface (UI) presenting pedagogical tasks of varied type and multiple cursors are presented on a single display. Each cursor is assigned to a particular user of multiple users. Actions associated with cursor control event data are mapped to particular users. Relative successes of respective ones of the users in completing particular types of pedagogical tasks of are determined.

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 shows an exemplary system for a multi-user multi-input application for education, according to one embodiment.

FIG. 2 shows an exemplary graphical user interface (GUI) for a multi-user multi-input application for education, according to one embodiment.

FIG. 3 shows an exemplary procedure for a multi-user multi-input application for education, according to one embodiment.

### DETAILED DESCRIPTION

### An Exemplary System

Although not required, systems and methods for a multi-user multi-input application for education are described in the general context of computer-executable instructions executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

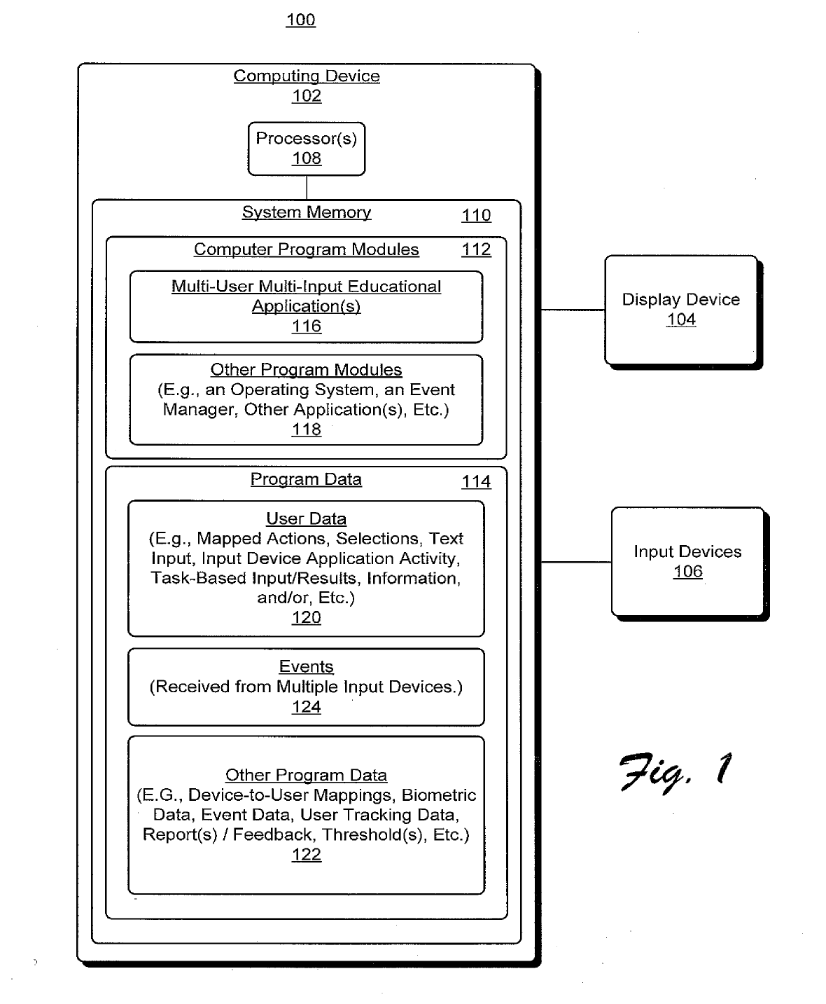

FIG. 1 shows an exemplary system 100 for a multi-user multi-input application for education, according to one embodiment. System 100 includes, for example, a computing device 102 coupled to a display device 104 and multiple input devices 106. Computing device 102 represents any type of computing device such as a general purpose computing device, a server, a laptop, a mobile computing device, etc. Display device 104 represents, for example, a monitor, an LCD, a projector, etc. Input devices 106 include, for example, any combination of pointing device(s) such as one or more mice, pen(s), keyboard(s), joystick(s), microphone(s), speaker(s), and/or so on. In this implementation, input devices 106 are directly or wirelessly coupled to computing device 102. Although multiple examples of input devices 106 have been described, it can be appreciated that any type of input device 106 can be used in the multi-user architecture of computing device 102 for supplying parallel streams of user input to computing device 102.

For example, in one implementation, one or more input devices 106 represent personal digital assistants (PDAs) configured to allow each user to send input from their PDAs to computing device 102 as if the user was using, for example, a mouse and/or keyboard connected to computing device 102.

Computing device 102 includes one or more processors 108 coupled to system memory 110. The system memory 106 includes volatile memory (e.g., RAM) and non-volatile memory (e.g., ROM, Flash, hard disk, optical, etc.). System memory 110 includes computer program modules 112 and program data 114. Processor(s) 108 fetch and execute program instructions from respective ones of the computer program modules 112. Program modules 112 include, for example, multi-user and multi-input educational application(s) 116 (“application 116”) and “other program modules” 118 such as an operating system to provide a runtime environment, etc.

Application 116 represents each input device 106 with a respective cursor control displayed in a UI (displayed on, or by, display device 104). Each user of application 116 utilizes a respective input device 106 and corresponding cursor to interface with application 116. Application 116 is configured to independently process the multiple streams of event data input received from respective ones of input devices 106. For example, if one user presses a particular button on an input device 106, and then a different user releases a different button on a different input device 106, application 116 will receive (e.g., from an event manager program module) the appropriate input device events in the correct window logic for processing, etc. In one implementation, each user can customize the look and feel of a corresponding cursor and/or actions associated with the cursor. For example, in one implementation, application 116 allows a user to: (a) select the color, shape, and/or image (e.g., user photograph, etc.) associated with the cursor utilized by the user; (b) assign one or more sounds to the cursor for replay responsive to certain actions and/or results; (c) specify selected object highlight color, etc. In one implementation, cursor look and feel is customized via a menu item, a preferences dialog, and/or etc.

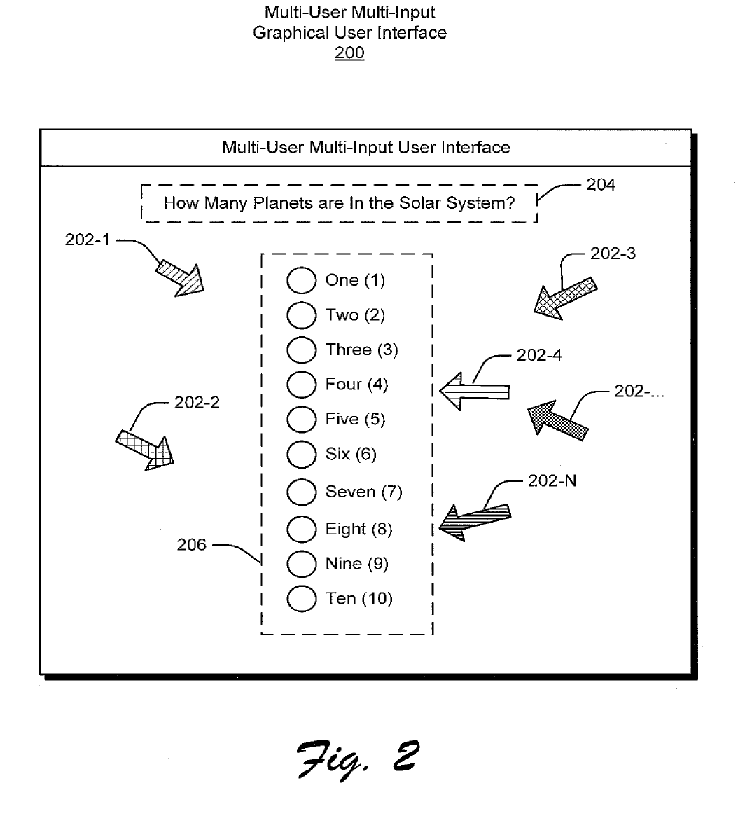

FIG. 2 shows an exemplary GUI 200 presented by a multi-user multi-input educational application, according to one embodiment. GUI 200 includes a respective cursor 202 (e.g., cursors 202-1 through 202-N) for each of multiple users interfacing with GUI 200. In this example, each user customized the look of the user's associated cursor 202. For purposes of exemplary illustration, such customization is shown as different types of hatches in the graphical depictions of the cursors 202.

Referring to FIG. 1, application 116 collects user data 120 to track each user's interfacing activity (e.g., mouse moves, object selections, text inputs, etc.) with application 116 (i.e., with the UI of application 116, e.g., please see the example of FIG. 2). To this end, and in one implementation, each input device 106 is assigned a unique input device identifier. Each respective user of application 116 is then mapped (assigned) to a particular input device 106. Input device-to-user mappings can be made in many different manners. In one implementation, for example, an administrator interfaces with a dialog box or other UI control presented by application 116 to assign a particular input device 106 to a particular user or group of users. In another implementation, application 116 prompts user(s) to input a respective name, alias, or other unique user identifier while using a particular input device 106. That identifier is them mapped to the particular input device 106.

In another implementation, for example, application 116 receives biometric data from input devices 106. Biometric data includes, for example, fingerprints, voiceprints, historical cursor control or input device 106 movement patterns, etc. Biometric data (or movement patterns) received from an input device 106 corresponds to a specific user of the input device 106. Application 106 compares received biometric data to archived biometric data and/or archived input device movement patterns associated with multiple possible users of application 116. For each input device 106, if there is a match between biometric data received from the input device 106 and archived data for a particular user, application 116 maps the input device 106 to the particular user. Although several examples of mapping input devices 106 to respective users of application 116 have been described, many other techniques could also be used to map respective ones of input devices 106 to respective users of application 116. For purposes of exemplary illustration, input device-to-user mappings are shown as respective portions of “other program data” 122.

Responsive to end-user interaction with application 116, event(s) 124 corresponding to the interaction(s) are placed into an event queue. Such interaction includes, for example, selecting, moving, resizing, or otherwise interfacing with a display object, inputting text, etc. In this implementation, the event queue is serviced by a multi-user and multi-input event manager (the “event manager” is shown as a respective portion of “other program modules” 118). In one implementation, the event manager is part of the operating system. Each event 124 indicates a particular input device 106 that generated the event 124, an event type, and data associated with the event type. Event types include, for example, mouse move events, selection events, and/or so on. Event data includes, for example, on-screen cursor positional coordinates, an indication of whether a user performed one or multiple clicks to generate the event, an indication of the UI window associated with the event etc. The event manager sends events 124 to application 116 for processing. The particular processing performed by application 116 is arbitrary and a function of the particular architecture of application 116. Exemplary such architectures are now described.

Thus, application 116 provides personalized online and/or off-line feedback to user(s), paces presented tasks and/or changes interaction scenarios.

### Exemplary Multi-User Multi-Input Educational Application Scenarios

In one implementation, application 116 is an educational (pedagogical) application and/or game directed to assisting multiple users interacting with the application to learn something. What a user actually learns is arbitrary. In this example, multiple people are in a same room collaborating, discussing, annotating, and/or editing aspects of the presentation, which is displayed by a single display device 104. By assigning each user a particular cursor control, each independently interacts with one or more portions of the presentation. Such interaction can be in serial and/or in parallel with other users. Responsive to receiving events 124 from respective input devices 106, the application maps each event to a particular user. Thus, the application knows exactly how each user is responding to the presentation. The application uses this knowledge to present customizable collaborative and/or competitive educational scenarios and feedback (online and/or offline feedback) based on user progress. In one implementation, for example, the application uses this knowledge to dynamically customize and set task parameters such as pace of the task, task difficulty, etc, for respective users of the application.

In one implementation, for example, application 116 poses a question (or presents a different type of task) to the multiple users. Application 116 may present user interface (UI) control(s) for one or more of the users to supply a respective answer to the posed question using their respective input devices 106. Such UI controls include, for example, multiple-choice buttons, text input box(es), drop-down menu(s), lists, etc. In one implementation, each user is presented with a respective set of user interface controls so that each user may enter their respective answer(s) in parallel with other users providing their respective inputs. In one example, respective users select and drag answers (e.g., words or phrases from a list of words, numerical answers, shapes, colors, objects representing sounds or other objects, etc.) from a collection of possible answers (e.g., in a commonly accessible area) into a UI control representing a collection area (e.g., a basket) associated with respective ones of the users, etc. In one implementation, only user(s) associated with a particular basket can input items/answers/information into the basket.

FIG. 2 shows an exemplary GUI 200 presented by a multi-user multi-input application, according to one embodiment. In this example, GUI 200 presents a question 204 to the multiple users of application 116 (FIG. 1). GUI 200 displays UI 206 control(s) for one or more of the users to supply a respective answer to the posed question 204 using their respective cursor 202 (e.g., one of cursors 202-1 through 202-N). In this example, such UI controls include selectable radio buttons.

In one implementation, application 116 (FIG. 1) assigns a certain number of points (± or zero points) to user(s) that select a correct response, not a best response, and/or an incorrect response to a posed question (or task). In one embodiment, responsive to a user selecting a correct response, an incorrect response, or not the best response to one or more of a presented set of questions, application 116 flashes a particular color and/or plays a sound associated with the cursor that selected the response. The color and/or sound may be particular to the type of response. In one implementation, after a particular user has selected a correct response, application 116 allows other users to select the correct response before finishing the task or otherwise moving to a next task. This scenario facilitates learning by all users of the application.

In one implementation, for example, application 116 presents a task for completion to the multiple users. Such a task can be any type of task or game (e.g., generating words from a pool of letters, chess, etc.), dependent on the particular implementation of application 116. In one example of this scenario, the application presents a number of components (e.g., switches, batteries, resistors, bulbs, and/or so on) for serial assembly by each user and/or collaborative assembly by all or subsets (groups) of the users. Respective ones of the users connect the components into an assembly (e.g., an electronic circuit, etc.). Responsive to one or more users completing the task, application 116 provides the users with feedback appropriate the particular task. For instance, exemplary feedback may include presenting a glowing/lit bulb to represent a correctly assembled electrical circuit, illustrating a chemical reaction to indicate that chemicals and/or reagents were combined in proper ratios, audible feedback, and/or so on.

In one implementation, application 116 segments a particular task into subtasks. The sub-tasks are then distributed to specific ones of multiple users of the application for respective completion. Only when all subtasks are completed (or particular ones of the subtasks are completed) is the task completed. For instance, consider a task to build an electronic circuit. In this example, the application subdivides the task into tasks to position circuit wires, switches, capacitors, etc., install a battery, and/or so on. A certain number of the users will be allowed to position the circuit wires, a second set of user(s) will be allowed to position switches, install the battery, etc. Only when the various subtasks are completed via user collaboration is the task completed.

In one implementation, application 116 does not implement certain global actions (e.g., exiting a task, quitting application 116, etc), unless a certain threshold number of the users agree to perform the global action.

### Exemplary Multi-User Multi-Input User Assessment and Pacing

In one implementation, application 116 tracks progress of one or more users utilizing respective ones of input devices 106 to interface with application 116 (or some other application). Such tracking involves, for example, tracking correct and incorrect responses to presented task(s), logging user activity (via events received for a corresponding input device 106) over time to determine intensity of user participation and engagement with on-screen activity, generating reports for analysis to rate user progress independently and/or in comparison to one or more different users, and/or so on. In one embodiment, for example, application 116 estimates competency of a user in view of the number of correct and/or incorrect response(s) received from the user to posed task(s). In one implementation, application 106 evaluates patterns of incorrect responses to predict, using known probabilistic algorithms, whether the use is just providing random responses. In one implementation, application 116 correlates identified amounts of user participation with the user's performance in terms of correct and/or incorrect responses provided by the user.

In a competitive task scenario, a particular user may not be able to react quickly enough to move a cursor to the appropriate place on the UI to select/input a correct response to a task before a different user provides the correct response. In one implementation, application 116 addresses this scenario by adapting dynamics of its UI to reflect pace(s) and/or intents associated with at least a subset of users interfacing with the UI. This adaptation is directed at making activities presented by application 116 easier for user(s) that are lagging behind and more challenging for user(s) that are doing well. To this end, application 116 tracks cursor movement of at least a subset of users to predict where each user was attempting to move (e.g., to select a response or provide other input). In this manner, application 116 tracks pace and probable intent of the user for analysis (besides allowing for activity replay). Application 116 uses these identified pace(s) and/or probable intent(s) to differentially handicapping and/or differentially assisting respective one(s) of the users as compared to other one(s) of the users of application 116.

For example, in one implementation, application 116 dynamically changes the size (dimension) of selection hotspots next to correct and/or incorrect response(s) to a posed task (e.g., a question) as a function of which particular user's cursor is near or on the hotspot. A hotspot is an area of the UI presented by application 116 (or other application) on which a user selects an object to provide input, or an area over which the user hovers a cursor for extra information-processing. In one implementation, application 116 configures size of hotspot(s) based on whether a user is doing well or lagging behind as compared to the progress of other user(s). For example, in one implementation, if a user is doing well, application 116 reduces the size of hotspot(s) near the user's cursor. In this example, if a user is lagging behind other users, application 116 increases the size of hotspot(s) near the user's cursor. These exemplary operations spatially locate hotspot(s) for selection (e.g., a hotspot associated with a correct response to a task) closer to a cursor mapped to a user that is having some amount of completing the task (or has had difficulty completing other task(s)).

In another example, application 116 configures UI object selection criteria based on user progress in completing a presented task. Such selection criteria includes, for example, changing a number of clicks for a user to select an object or otherwise provide input to application 116. In one implementation, for example, application 166 configures selection criteria for a user that is progressing well at a task to select an object by double-clicking the object. In this example, application 166 configures selection criteria for a user that is not progressing as well at a task to select an object by single-clicking the object. In another example, application 116 does not present or load a next question (or a new task) until each user (or some configurable subset of users) has selected a correct response to a task.

In another example, and in one implementation, application 116 presents a controlled spatial arrangement of pseudo-random on-screen content. For example, in scenarios presenting tasks that include multiple choice question(s) and answer(s), application 116 distributes presentation of the multiple choice buttons around the screen in random, static, and/or changing arrangements. In another example, a button for a correct option is presented in close proximity to a cursor of a user that is lagging behind.

In one implementation, application 116 adapts dynamics of the UI by identifying type(s) of tasks that are successfully completed by user(s) that are not doing as well as other users, or not performing well on a task in view of other objective measurement(s) (e.g. an amount of time taken to complete a task, etc). Task types are arbitrary and can include many different types depending on the objective(s) of application 116. For example, task types include certain types of questions, different types of task completion criteria (e.g. collaborative, competitive, or individual), tasks associated with various subjects or genres, etc. Responsive to such identification, application 116 presents these task types with increased frequency. This reduces frequency of presentation of task types successfully completed by user(s) that are not lagging behind, essentially leveling competition for user(s) that are not progressing as well.

By storing user-to-task progress results and analysis (respective portions of “user data” 120), application 116 knows the particular type(s) of task(s) that a user performs well on, and type(s) of task(s) that the user performs less well on. In view of these determinations, certain types of sub-tasks (and in one implementation, certain types of non-subdivided tasks) are assigned to certain users. In one implementation, for example, application 116 divides a task into subtasks and distributes the sub-tasks to respective sets of users. In this example, application 116 assigns simple (less complex) sub-task(s) to user(s) not performing as well in responding to tasks as other user(s), and more difficult sub-tasks to user(s) that are progressing well.

### An Exemplary Procedure

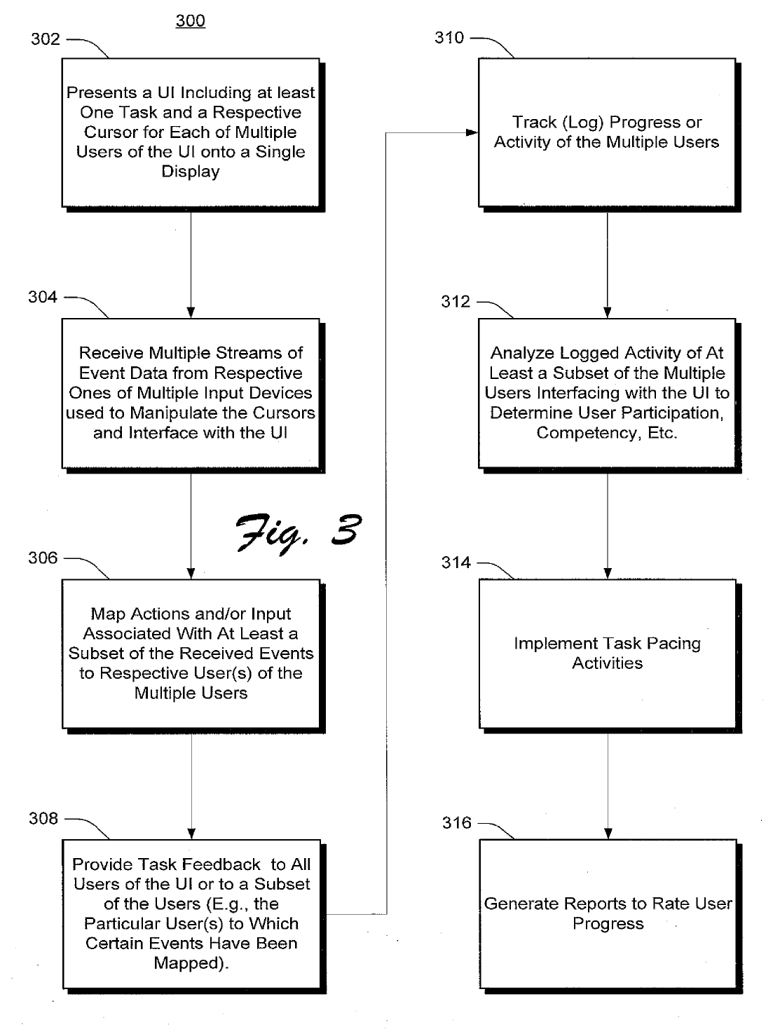

FIG. 3 shows an exemplary procedure 300 for a multi-user multi-input application for education, according to one embodiment. For purposes of exemplary illustration and description, the operations of procedure 300 are described with respect to components of FIGS. 1 and 2. In the following procedural description, the first number of a reference number indicates the drawing where the component was first identified. For example, the first numeral of application 116 is a “1,” thus application 116 is first presented in FIG. 1. In another example, the first numeral of cursor 202 is a “2”, thus cursor 202 was first presented in FIG. 2. Exemplary operations of procedure 300, as shown in FIG. 3, start with the numeral “3”.

Although the exemplary operations of procedure 300 are shown in a certain order and include a certain number of operations, the illustrated operational order and included (executed) operations can be different based on one or more of the particular implementation of procedure 300 and based on user input to a multi-input multi-user application (e.g., application 116 of FIG. 1). For example, although block 308 is shown and described (below) prior to operations associated with blocks 310 through 316, operations associated with blocks 318 through 316 could be implemented in any order. Additionally, in any one particular execution of the multi-input multi-user application, an entity's interaction with the application may result in a particular operation of a block not being implemented. For example, an entity (e.g., user, administrator, teacher, etc.) may not generate a report. In such a scenario, the execution path of procedure 300 may not include operations of block 316.

Referring to FIG. 3, block 302 presents a UI including at least one task and a respective cursor for each of multiple users of the UI onto a single display. Depending on the particular implementation of application 116, the task may be presented to the multiple users for any combination of independent and collaborative user efforts to solve, complete, or otherwise work-on the task. Each cursor is controlled by a respective input device such as a mouse, pen, joystick, touch-pad, microphone (voice recognition control), and/or so on). The input devices provide multiple streams of input to the application responsive to user interactions with the input devices and the UI (e.g., mouse movements, selections, etc.). Each input device is assigned to a particular one user of the multiple users.

In one implementation, for example, application 116 (FIG. 1) implements the operations of block 302 by presenting GUI 200 (FIG. 2) including at least one task (e.g., a question answer scenario, and/or etc.) and a respective cursor 202 for each of multiple users of the GUI onto a single display (e.g., display device 104). Each cursor 202 is for use by a respective one user of multiple users to interface with GUI 200 and complete the task.

Block 304, responsive to respective ones of the users interfacing with the UI with respective ones of the multiple input devices, receives multiple streams of event data. Event data associated with a particular input device includes, for example, a unique ID identifying the input device, positional coordinates for the input device's corresponding cursor control, an event type (e.g., a pointing device move event, a single click event, a double click event, and/or so on), a window identifier indicating the particular window of the UI that will handle the event and/or so on. In one implementation, for example, responsive to respective ones of multiple users interfacing with application 116 with respective ones of multiple input devices 106, application 116 implements the operations of block 304 by receiving multiple independent streams of events 124 from input devices 106.

Block 306 maps actions and/or input associated with at least a subset of the events to respective user(s) of the multiple users. For example, in one implementation, application 116 implements the operations of block 306 by mapping actions and/or task-based input/results associated with at least a subset of the events 124 to respective user(s) of multiple user(s). These mapped events are shown as a respective portion of user data 120. In this implementation, such mapping is one user-to-one input device 106. In another implementation, more than one user (a group of users) is associated with a particular input device 106. For example, the multiple users are divided into at least two groups, and each group is associated with a particular input device 106 (and corresponding cursor).

Block 308 provides task feedback responsive to mapping received input device events to specific users (please see the mapped events of block 306). Such feedback includes, for example, one or more of the following:
Providing the user(s) with feedback associated with the mapped events. Such feedback includes, for example, one of more of the following.
   Indicating that an answer to a posed question was correct, incorrect or not the best answer.
   Identifying a cursor user that provided a correct answer to a posed question, completed a task, and/or etc. Such identifications, for example can be by flashing a color and/or playing a sound associated with the cursor/user, showing the result of a completed task (e.g., illustrating a lit light as a result of completing a task to build a working electrical circuit, etc), and/or so on.
Assigning a certain number of points (± or zero points) to user(s) that select a correct answer, not a best answer, and/or an incorrect answer to a posed question.
Etc.

### In one implementation, application 116 implements the operations of block 308 by providing the task feedback to the user(s).

Block 310 tracks (logs) progress of user(s) (i.e., user activity). Such tracking includes, for example, tracking correct and incorrect selections/answers, logging activity in terms of input device events received per user and per unit of time, etc. In one implementation, application 116 implements the operations of block 310 by tracking progress of user(s). This tracked progress is shown as respective portions of “user data” 120.

Block 312 analyzes logged activity of at least a subset of the multiple users interfacing with the multi-input multi-user application to determine user participation, competency, etc. In one implementation, application 116 implements the operations of block 312 by analyzing logged activity (i.e., shown as respective portions of “user data” 120) of at least a subset of the multiple users interfacing with the multi-input multi-user application 116. Such analysis includes, for example, one or more of the following activities:
Determining intensity of user participation with on-screen activity.
Estimating competency of a user. Such estimations can be made in view of many different and arbitrary types of criteria. In one implementation, such criteria include, for example, the number of correct and/or incorrect answer(s) by a user to posed questions, amount(s) of time taken by a user to complete one or more tasks, number(s) of task(s) successfully and/or partially completed by a user, evaluating patterns of incorrect selections to predict, using probabilistic algorithms, whether a use is just performing random selections, and/or so on.
Etc.

Block 314 dynamically implements one or more pacing based activities responsive to mapping received input device events to specific users (please see the mapped events of block 306). Such pacing activities include, for example, one or more of the following:
Adapting a UI to reflect pace(s) associated with at least a subset of users interfacing with a task presented by the multi-user multi-input application (e.g., application 116 or some other application).
After at least one user, for example, has provided a correct answer to a posed question, completed a task, and/or etc., allowing other users to select a correct answer to the question, complete the task, and/or etc.
Configuring a user's selection criteria based on progress of the user (e.g., changing a number of clicks for a user to select an object, etc.).
Not presenting a next question until each user (or some configurable subset of users) of the multi-user multi-input application has selected a correct answer to a currently displayed/presented question;
Presenting, based on user progress and/or predicted intent, a controlled spatial arrangement of pseudo-random on-screen content;
Tracking cursor movement of at least a subset of users to replay a particular scenario, predict user intent, etc.
Displaying, with an increased frequency, type(s) of questions (e.g., questions based on particular genres, etc.) or tasks that are correctly answered (or completed) by user(s) that are not doing well as compared to other users or other measuring criteria (e.g. time, etc);
Assigning simple task(s) to user(s) not performing as well as desired and more difficult/complex tasks to user(s) that are progressing well; and/or
Etc.

### In one implementation, application 116 implements the operations of block 314 by pacing task activity.

Block 316 generates reports to rate user progress independently and/or in comparison to one or more different users. Such entities include, for example, one or more users of the multi-input multi-user application, teachers, administrators, etc. In one implementation, application 116 implements the operations of block 316 by generating reports for entities to rate user progress independently and/or in comparison to one or more different users.

### Conclusion

Although systems and methods for a multi-user multi-input application for education have been described in language specific to structural features and/or methodological operations or actions, it is understood that the implementations defined in the appended claims are not necessarily limited to the specific features or actions described above. Rather, the specific features of system 100 and operations of procedure 200 are disclosed as exemplary forms of implementing the claimed subject matter.

1. A computer-implemented method comprising:
displaying, by a single display coupled to computing device, a user interface (UI) associated with one or more pedagogical tasks and multiple input controls, each input control for use by a respective user of multiple users to control at least a portion of the UI;
mapping actions associated with at least a subset of event data to one or more respective users of the multiple users, the event data being received from respective ones of the input controls; and
determining relative successes of at least a subset of the users in successful completion of the pedagogical tasks.

2. The method of claim 1, wherein a task of the pedagogical tasks is for independent, competitive, or collaborative efforts by at least a subset of the multiple users.

3. The method of claim 1, further comprising responsive to determining the relative successes, presenting one or more types of pedagogical tasks on the UI with increased or decreased frequency, the one or more types having been determined to be successfully or unsuccessfully completed by user(s) of the multiple users.

4. The method of claim 1, further comprising:
providing feedback to at least a subset of the multiple users, the feedback being based on the mapping; and
wherein the feedback comprises one or more of the following:
indicating that a user response to a task of the pedagogical tasks was correct, incorrect, or not a best response;
identifying an input control associated with successful completion of the task; and
assigning a certain number of points to user(s) that fully or partially completed the task.

5. The method of claim 1, further comprising, assigning at least input control of the multiple input controls to a group of the multiple users, the group comprising less than all of the multiple users.

6. The method of claim 1, further comprising, generating a report to evaluate progress of one or more users of the multiple users, the reports being based on at least a subset of the actions.

7. The method of claim 1, further comprising, determining progress of at least a subset of the multiple users based on actions mapped to respective ones of the at least a subset.

8. The method of claim 7, wherein determining the progress comprises one or more of tracking correct responses, logging incorrect responses, evaluating user participation in resolution of a task of the pedagogical tasks, correlating the user participation with performance on the task, and determining user intent.

9. The method of claim 1, further comprising dynamically changing the UI to provide one or more of additional competition, collaboration, and educational scenarios to respective one(s) of the multiple users, the changing being based on at least a subset of mapped ones of the actions that indicate competence of a user of the multiple users in completing a task of the pedagogical tasks.

10. The method of claim 9, wherein dynamically changing the UI comprises one or more of the following:
responsive to successful completion of a task of the pedagogical tasks by at least one user of the multiple users, allowing other users to successfully complete the task before introducing a next task;
changing UI object selection criteria for one or more of the multiple users;
presenting to one or more of the multiple users, based on one or more of user progress and predicted intent, a controlled spatial arrangement of pseudo-random content in the UI;
replaying a particular scenario associated with the task; and
wherein the task can be divided into sub-tasks:
assigning simple sub-tasks to user(s) of the multiple users that are not as successful in completing certain types of pedagogical task(s) as compared to other users of the multiple users; and
assigning complex sub-tasks to user(s) of the multiple users that are more successful in completing certain types of pedagogical task(s) as compared to other users of the multiple users.

11. The method of claim 1, further comprising analyzing logged activity of at least a subset of the multiple users to determine one or more of intensity of participation associated with a task of the pedagogical tasks and competency in the task.

12. The method of claim 11, wherein competency is based on one or more criteria comprising a number of correct solution(s), a number of incorrect response(s), amount(s) of time taken to complete the task, and a determination that a user is making random selections.

13. A computer-readable medium comprising computer-program instructions for a multi-user multi-input application for education, the computer-program instructions being executable by a processor on a single computing device to perform operations comprising:
receiving inputs from multiple input devices, the inputs for multiple users to independently interface with a UI presented on the single computing device; and
dynamically customizing an educational task presented by the UI based on inputs from at least a subset of the multiple users, the dynamically customizing being implemented with a change to one or more of dimension, position, and selection criteria of an object presented by the UI, the changing being based on an evaluation of success for a user with respect to one or more portions of the educational task.

14. The computer-readable medium of claim 13, wherein the UI object comprise a selection hotspot.

15. The computer-readable medium of claim 13, wherein the dynamically customizing further comprises not presenting a new educational task until each user has successfully completed a configurable portion of the educational task.

16. The computer-readable medium of claim 13, wherein the dynamically customizing further comprises spatially locating a correct response to the educational task in close proximity to a cursor associated with a user that is lagging behind other users interfacing with the educational task.

17. The computer-readable medium of claim 13, wherein the operations further comprise presenting personalized online and off-line feedback for evaluation, the feedback being based on independent and collaborative interaction with the educational task by the multiple users.

18. A computing device comprising:
a processor; and
a memory coupled to the processor, the memory comprising computer-program instructions executable by the processor to perform operations comprising:
receiving pointing device input from multiple users, each user being associated with a particular one pointing device;
correlating the pointing device input to associated ones of the multiple users;
responsive to correlating the pointing device input, determining respective user participation with a UI of a collaborative educational computer program that is executing on the computing device, the UI being presented in a single main UI window by a single display device operatively coupled to the computing device, the collaborative educational computer program being configured to allow each user to provide independent input to at least a portion of UI object(s) presented in the main UI window; and
dynamically changing particular aspects of educational scenarios provided by the collaborative educational computer program for a subset of the multiple users, the particular aspects being based on determining the respective user participation.

19. The computing device of claim 18, wherein the particular aspects determine whether the educational scenario is more competitive, collaborative, or independent for respective ones of the subset of users based on corresponding determinations of participation of each user in the subset of users.

20. The computing device of claim 18, further comprising providing feedback to at least a subset of the multiple users, the feedback flashing a color or changing a size of a cursor control corresponding to a user of the multiple users that provided a correct response to a presented task.
